(19) United States
(12) Patent Application Publication
(10) Pub. No.: US 2013/0327311 A1
(43) Pub. Date: Dec. 12, 2013

(54) STOVETOP COVER GUARD

(71) Applicant: Princess Johnson, Brooklyn, NY (US)

(72) Inventor: Princess Johnson, Brooklyn, NY (US)

(21) Appl. No.: 13/491,898

(22) Filed: Jun. 8, 2012

(51) Int. Cl. F24C 15/12; B23P 11/00

(52) U.S. Cl. 126/214 D; 29/428

(57) ABSTRACT

A stovetop surface covering system is disclosed. A stovetop surface has a top portion and a bottom portion. A covering device is configured to fit in between the top portion of the stovetop surface and the bottom portion of the stovetop surface. The covering device includes a plurality of adjoining walls, wherein the plurality of adjoining walls operate as a shield to prohibit touching a top portion of the stove top surface.

### FIELD OF THE INVENTION

The present invention relates to a stovetop cover guard.

### BACKGROUND OF THE INVENTION

Generally, stoves have been used for generations and generations to cook or heat food within a period of time. Since stoves were developed soon afterwards stove covers were developed. There are several stove covers that can be reviewed including U.S. Pat. No. 5,331,945, U.S. Pat No. 511,797, U.S. Pat. No. 386,945, U.S. Pat No. 6,263,869, U.S. Pat. No. 4,922,888 and U.S. Pat No. 6,763,825. However, there are problems without the aforementioned stove covers because they don't prevent anyone from touching the top portion of the stovetop surface.

There is a need for a device for the stove that prevents persons from contacting a surface of the top portion of a stovetop surface in order to prevent the person from injuring himself or herself.

### SUMMARY OF THE INVENTION

The present invention has been accomplished in view of the above-mentioned technical background and it is an object of the present invention to provide a stovetop cover guard.

In one embodiment of the invention, a stovetop surface system is disclosed. A stovetop surface has a top portion and a bottom portion. A covering member is configured to fit in between the top portion of the stovetop surface and the bottom portion of the stovetop surface. The covering device includes a plurality of adjoining walls, wherein the plurality of adjoining walls prohibits contact with the top portion of the stove top surface.

In another embodiment of the invention, a method for protecting a stovetop surface is disclosed. The method comprises: lifting a top portion of a stovetop surface;

inserting a cover with a plurality of walls in between the top portion of the stove and a bottom portion of the stovetop surface; and pushing the top portion of the stovetop surface onto the cover with the plurality of walls to hold the cover with the plurality of walls in place in between the top portion of the stovetop surface and the bottom portion of the stovetop surface.

In yet another embodiment of the invention, a stovetop surface covering system is disclosed. A stovetop surface having a top portion and a bottom portion. A first sidewall configured to fit in between a front side of the top portion of the stovetop surface and a front side of the bottom portion of the stovetop surface. The first sidewall prohibits contact with the front side top portion of the stovetop surface.

### BRIEF DESCRIPTION OF THE DRAWINGS

These and other advantages of the present invention will become more apparent as the following description is read in conjunction with the accompanying drawings, wherein:

FIG. 1 is a schematic perspective of a stove with a stovetop guard;

FIG. 2 is a schematic view of the stovetop guard of FIG. 1;

FIGS. 3A, 3B 3C are different perspective views of another stovetop cover; and

FIG. 4 is a flow chart of how the stovetop guard is utilized on the stove.

### DETAILED DESCRIPTION OF THE INVENTION

The embodiments of the invention are described with reference to the drawings, where like components are identified with the same numerals. The descriptions of the embodiments are exemplary and are not intended to limit the scope of the invention.

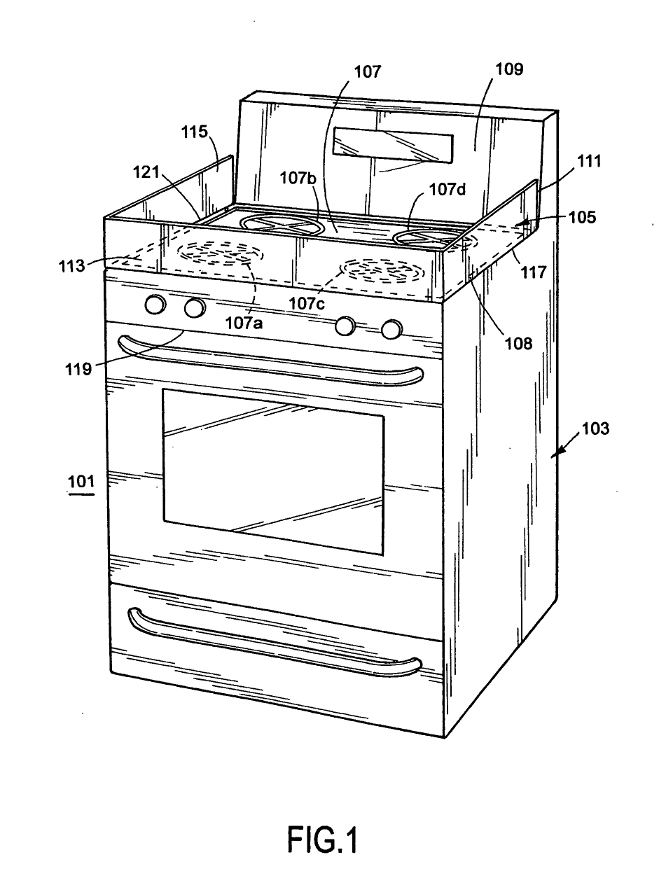

FIG. 1 is a schematic perspective of a stove with a stovetop guard. A stovetop guard system 101 includes a stove 103 and a covering member 105. Stove 103 has a top portion stovetop surface 107, a bottom portion stovetop surface 108, a right peripheral stovetop area 117, a middle peripheral stovetop area 119 and a left peripheral stovetop area 121. Top portion stovetop surface 107 may include a first burner 107a, a second burner 107b, a third burner 107c and a fourth burner 107d. In another embodiment of the invention, the stove 103 may have one burner or more than 4 burners. First burner 107a, second burner 107b, third burner 107c and burner 107d are used for cooking food in a pot, pan or frying pan or any component that is capable of receiving heat and distributing the heat for the food. A panel 109 is orientated generally perpendicular to the top surface of the stove 103. Panel 109 has a plurality of actuating means for actuating the stove 103.

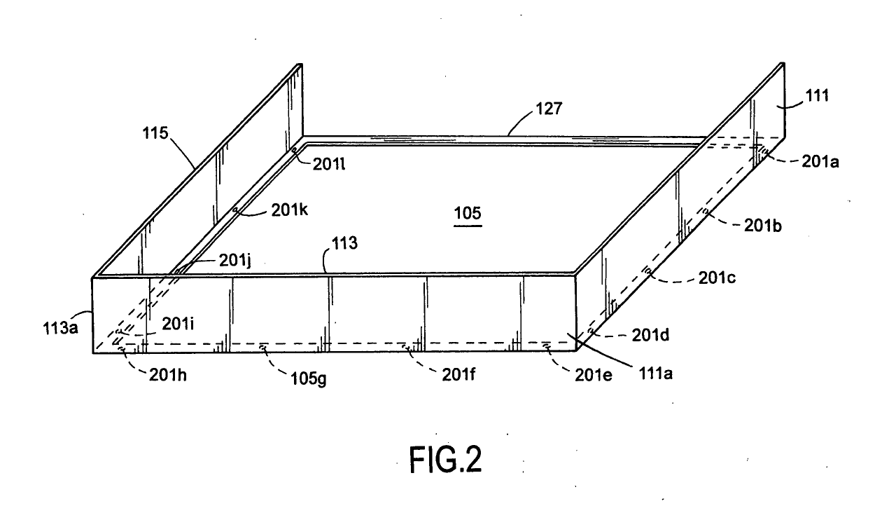

Covering member 105 has a plurality of adjoining walls 111, 113 and 115. Right adjoining wall 111 is connected to front adjoining wall 113, which is coupled to the left adjoining wall 115. Referring to FIG. 2, the plurality adjoining walls 111, 113 and 115 of the covering member 105 are affixed to each other. Adjoining wall 111 is affixed to adjoining wall 113 by a corner brace 111a. Adjoining wall 113 is affixed to adjoining wall 115 by a corner brace 113a. Adjoining wall 111 is coupled to adjoining wall 115 by a bar member 127 that is able to fit under a back portion of the stove 103. The plurality of adjoining walls 111, 113 115 have a height in a range of 3 inches to 12 inches. Preferably, the height of the plurality of adjoining walls 111, 113 and 115 is 5 inches in order to prevent anyone from contacting the top portion of stovetop surface 107. The adjoining walls 111, 113 and 115 have a length in the range of 20-26 inches. Preferably, the adjoining walls 111 and 115 have a length of 22.5 inches. Preferably, the adjoin wall 113 has a length in the range of 24¾ inches. The width of the adjoining walls 111, 113 and 115 is in the range of 0.1 inches to 0.5 inches. Preferably, the width of the adjoining walls 111, 113 and 115 is 0.2 inches. Covering member 105 may be made of any type of metal such as iron, copper, stainless steel etc.

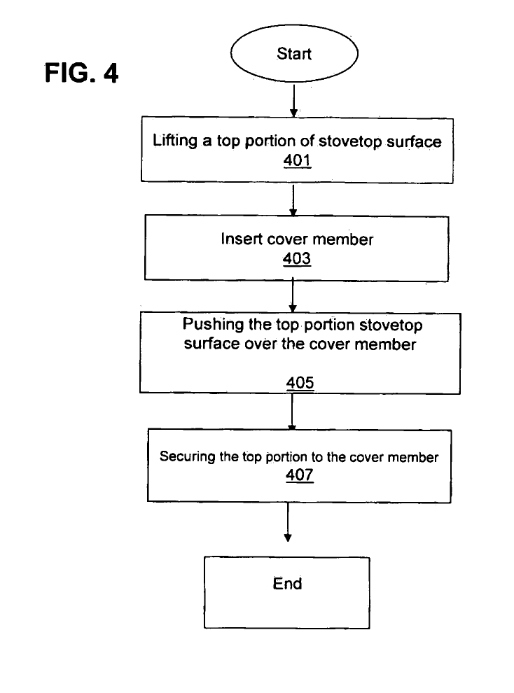

FIG. 4 shows a method for utilizing the cover member with the stove. At block 401, a top portion of the stovetop surface 107 is lifted by manual means or possibly mechanical or electric means. Next, at block 403, the cover member 105 with a plurality of walls 111, 113 and 115 is inserted around peripheral portions 117, 119 and 121 in between the top portion of the stovetop surface 107 and the stovetop surface bottom portion 108. Next at block 405, the top portion of the stovetop surface 107 is pushed onto the cover member 105, which is secured to the stovetop surface bottom portion 108. At block 407, the cover member 105 is secured to the top portion stovetop surface 107 and the stovetop surface by fastening members 201a, 201b, 201c, 201d, 201e, 201f, 201g, 201h, 201i, 201j, 201k and 201l at peripheral portions 117, 119 and 121 of the stove 101. The peripheral portions 117, 119 and 121 includes a plurality of holes where the fastening members 201a, 201b, 201c, 201d, 201e, 201f, 201g, 201h, 201i, 201j and 201k can go through the top portion of the stovetop surface 107 through the cover member 105 through the stovetop surface bottom portion 108 in order to secure the cover member 105 to the top portion to the stovetop surface 107 and the stovetop surface bottom portion 108. The fastening members 201a, 201b, 201c, 201d, 201e, 201f, 201g, 201h, 201i and 201j are nails, clamps, screws or fixtures used to connect typical metal objects to each other. Then the process ends.

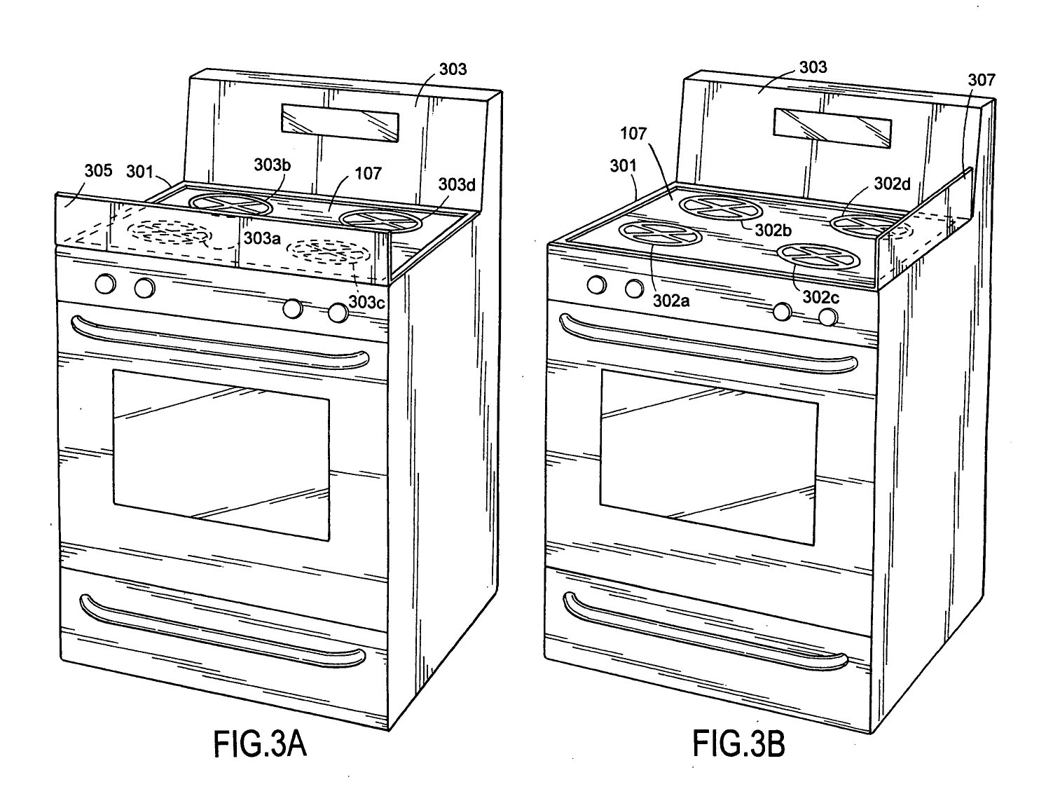

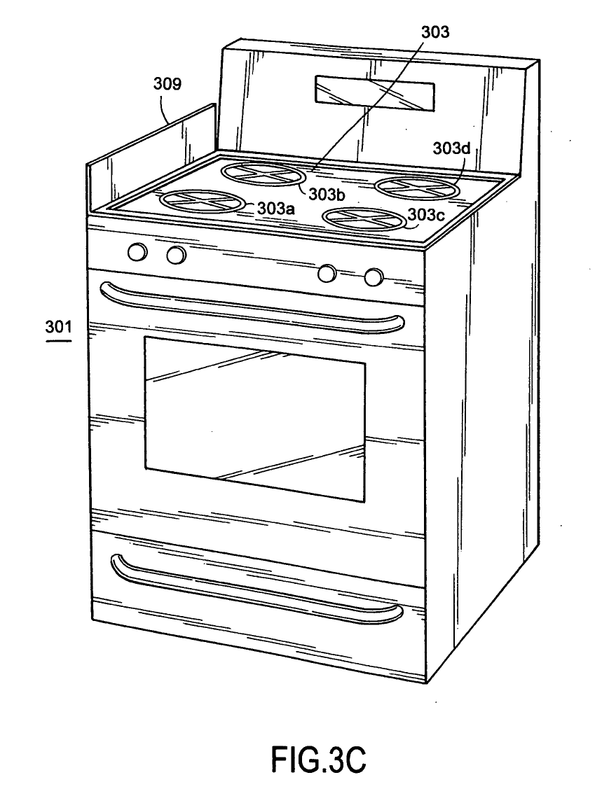

FIGS. 3A, 3B and 3C show another perspective view of other cover member. FIG. 3A includes a typical stove 301 with a top portion stovetop surface 303, a first burner 303a, second burner 303b, a third burner 303c, a fourth burner 303d and a first side wall 305. First side wall 305 is located in front of a top portion stovetop surface 107 and a front portion of a stovetop surface bottom portion 108. The first sidewall 305 has a height in the range of 3-8 inches, preferably 5 inches. The length of the first sidewall 305 is in the range of 20-26 inches, preferably 24 inches. The width of the first sidewall is in a range of 0.1 to 0.4 inches, preferably 0.2 inches. FIG. 3B includes a typical stove 301 with a top portion stovetop surface 303 and a second side wall 307. Second side wall 307 is located in front of a top portion stovetop surface 107 and a front portion of the stovetop surface bottom portion 108. Second sidewall 307 has the same length, height and width of sidewall 305. FIG. 3C includes a typical stove 301 with a top portion stovetop surface 303 and a third side wall 309. Third side wall 309 is located in front of a top portion stovetop surface 107 and a front portion of the stovetop surface bottom portion 108. Third sidewall 309 has the same length, width and height of sidewalls 305 and 307.

This invention provides a means to prevent a top portion of a stovetop surface from being contacted by anyone so the person doesn't get injured while trying to reach for a pot on top of the stove. A top portion of the stovetop surface is lifted then the cover member is inserted in between the top portion of the stove surface and the bottom portion of the stovetop surface. The cover member with its plurality of walls prevents anyone from touching the top portion of the stovetop surface.

Although the present invention has been described above in terms of specific embodiments, many modifications and variations of this invention can be made as will be obvious to those of ordinary skill in the art, without departing from its spirit and scope as set forth in the following claims.

What is claimed is:

1. A stovetop surface covering system, the system comprising:
a stovetop surface having a top portion and a bottom portion;
a covering device configured to fit in between the top portion of the stovetop surface and the bottom portion of the stovetop surface; and
the covering device includes a plurality of adjoining walls, wherein the plurality of walls operate as a shield to prohibit touching a top portion of the stove top surface.

2. The system of claim 1 wherein the plurality of walls has a height in a range of 4-8 inches.

3. The system of claim 1 wherein a plurality of pots are on the top portion of the stovetop surface.

4. A method for protecting a stovetop surface, the method comprising:
lifting a top portion of a stovetop surface;
inserting a cover with a plurality of walls in between the top portion of the stove and a bottom portion of the stovetop surface; and
pushing the top portion of the stovetop surface onto the cover with the plurality of walls to hold the cover with the plurality of walls in place in between the top portion of the stove top surface and the bottom portion of the stove top surface.

5. The method of claim 4, further comprising securing the top portion of the stovetop surface on the cover with the plurality of walls by inserting a plurality of securing components through the top portion of the stovetop surface through the cover with the plurality of walls to the bottom portion of the stovetop surface.

6. The method of claim 5, wherein the securing components are from the group consisting of nails and screws.

7. A stovetop surface covering system, the system comprising:
a stovetop surface having a top portion and a bottom portion;
a first sidewall configured to fit in between a front side of the top portion of the stovetop surface and a front side of the bottom portion of the stovetop surface; and
the first sidewall operates prohibits contact with the top portion of the stovetop surface.

8. The stovetop surface covering system of claim 7 further comprising:
a second sidewall configured to fit in between a left side of the top portion of the stovetop surface and a left side of the bottom portion of the stovetop surface, wherein the second sidewall prohibit contact with the top portion of the stovetop surface.

9. The stovetop surface covering system of claim 8 further comprising:
a third sidewall configured to fit in between a left side of the top portion of the stovetop surface and a left side of the bottom portion of the stovetop surface, wherein the third sidewall prohibits contacting the top portion of the stovetop surface.
